(19) United States
(12) Patent Application Publication
(10) Pub. No.: US 2011/0320998 A1
(43) Pub. Date: Dec. 29, 2011

(54) LIGHT-EMITTING DIODE SYSTEM DESIGNER

(76) Inventors: Jeffrey R. Perry, Cupertino, CA (US); Dien Mac, San Jose, CA (US); Khanh Vo, San Jose, CA (US); Shrikrishna Srinivasan, (US); Kristen Elserougi Kawar, (US); Phil Gibson, (US)

(21) Appl. No.: 13/169,379

(22) Filed: Jun. 27, 2011

Related U.S. Application Data
(60) Provisional application No. 61/359,219, filed on Jun. 28, 2010.

(51) Int. Cl. G06F 17/50

(52) U.S. Cl. 716/122

(57) ABSTRACT

A system may include a database configured to store information including characteristics of a plurality of components. The system may further include a server in communication with the database and configured to receive design parameters indicative of characteristics of an LED lighting solution; determine a plurality of LED lighting array designs, each design including at least one of a parallel and a series arrangement of LEDs and configured to provide an amount of light specified by the design parameters; for each one of at least a subset of the plurality of LED lighting array designs, determine an LED driver design configured to power the one of the LED lighting array designs; and generate at least one LED lighting solution, each LED lighting solution including one of the LED lighting array designs combined with one of the LED driver designs configured to power the one of the LED lighting arrays.

### CROSS-REFERENCE TO RELATED APPLICATIONS

This application claims the benefit of U.S. Provisional Patent Application Ser. No. 61/359,219, filed Jun. 28, 2010, entitled “LIGHT-EMITTING DIODE SYSTEM DESIGNER,” the contents of which is hereby incorporated by reference in its entirety.

### BACKGROUND

Light-emitting diode (LED) lighting systems are becoming increasingly popular due to their energy savings and long life compared to conventional tungsten filament and fluorescent lighting. Software based systems to assist in the design of power supplies for LED lighting systems exist, an example of which is National Semiconductor's WEBENCH LED Designer. However, these tools are limited in their ability to enable users to design LED lighting systems based on user requirements.

### BRIEF DESCRIPTION OF THE DRAWINGS

FIG. 1 illustrates an exemplary system for determining an LED lighting system.

FIG. 2 illustrates an exemplary modularization of the LED lighting system design tool.

FIG. 3 illustrates an exemplary process flow for the determination of LED lighting solutions.

FIG. 4 illustrates an alternate exemplary process flow for the determination of LED lighting solutions.

FIG. 5 illustrates an exemplary user interface for the input of design requirements and display of LED array designs.

FIG. 6 illustrates an alternate exemplary user interface for the input of design requirements and display of LED array designs, while allowing for customization of LED array designs.

FIG. 7 illustrates an exemplary user interface for receiving LED array design customizations.

FIG. 8 illustrates an exemplary user interface for the input of design requirements and display of LED array designs, including a customized LED array design.

FIG. 9 illustrates an exemplary user interface for the display of LED lighting solutions.

### DETAILED DESCRIPTION

LEDs are dynamic devices whose characteristics vary based on environmental factors. For example, LED light output may change with temperature and current. In order to provide a desired light output, these parameters must be understood or the LED lighting system may not be optimal. For example, the LED lighting system may be insufficient and not produce enough light, or may be overdesigned and use an excessive number of LEDs and waste resources.

This balancing is compounded by the fact that LEDs themselves generate heat when in operation. Further, if LED temperature reaches above a limit indicated by the LED manufacturer, the heat may reduce the lifetime of the LED or cause the LED to cease functioning entirely. Accordingly, heat may be required to be controlled by using a heat sink to draw heat from the LEDs. But, the cost and size of the heat sinks further affects the overall LED lighting system. An example of these factors affecting an overall lighting system is that more expensive LEDs that run more efficiently and that require a less expensive heat sink may provide for an LED lighting system that is cheaper overall than a system using cheaper LEDs that run less efficiently but require a more substantial heat sink. Existing tools fail to account for these and other factors when providing a proposed LED lighting solution.

LEDs typically require a level of current that is regulated at a constant level. This in turn requires that a special power supply be used to power the LEDs, often referred to as an LED driver. There are many factors to take into account when designing the LED driver. These factors include selection of an LED driver topology, such as buck (step down), boost (step up), buck/boost (step up and step down) or any other power supply topology. These various LED driver topologies may have different advantages in cost, complexity, footprint and/or efficiency. Further adding to the complexity, LED drivers may have limits on input voltage and output voltage that they can withstand, and also the current that they can provide. Thus, not all LED arrays may be supported by a given LED driver. In addition, the LED driver may be required to support alternating current (AC) or direct current (DC) input voltage, depending on what input voltage sources may be available.

The output voltage and output current that the LED driver must supply depends on how the LEDs are arranged. LEDs may be arranged into LED arrays, where the arrays may include multiple LEDs in series, in parallel or in combinations of the two. As one example, the total number of LEDs may be put into one series string. As another example, the LEDs may be divided up into multiple parallel strings. When LEDs are put into a series string, the total required voltage may be determined as a sum of the forward voltage of each LED plus a voltage drop across the current sense resistor, which may result in a high output voltage requirement for the LED driver. This may rule out drivers using the buck topology since the total output voltage must be less than the minimum input voltage for this topology to work. By comparison, when LEDs are put into parallel strings, the total current may be determined as a sum of the current of each parallel string, which may result in a high current requirement for the LED driver. This may exclude drivers using the boost topology since the switch current for boost topology is higher than the total load current. The following simplified equation may describe the relationship for boost topology as follows: Iout*(Vout/VinMin)/Driver Efficiency, where lout is the total load current, Vout is the total output voltage, VinMin is the minimum input voltage, and Driver Efficiency is the efficiency of the LED driver.

The total number of LEDs required for an application may be such that it results in uneven numbers of LEDs in different strings. This in turn may require different drivers for the different LED strings, which raises the complexity of the overall LED lighting system. To address this issue, the total number of LEDs may have to be changed so that all the strings have the same number of LEDs, and can then use the same LED driver for simplicity and to save on tooling and assembly costs. In addition, the physical arrangement of LEDs on the heat sink may result in uneven temperature distribution across the heat sink if there are fewer LEDs in one section of the heat sink. This may result in some of the LEDs running at different temperatures than others which could result in different light outputs across the LED array.

To address these and other factors, an LED lighting system design tool may make use of an automated system. The system may receive design requirements for an LED lighting system as input from a user. Based on the design requirements, the system may calculate different combinations of LEDs, heat sinks, arrays and LED drivers, and may present the results to the user in tabular and/or graphical form. The system may further allow the user to specify desired design goals, such as low price, high luminous efficacy (a measure of efficiency in the form of a ratio of an amount of light produced compared to an amount of power required to produce the light) and small footprint through the use of graphical user interface (GUI) elements such as a knob control. Through use of the system, a user may quickly design and optimize an LED lighting system customized to the user's needs.

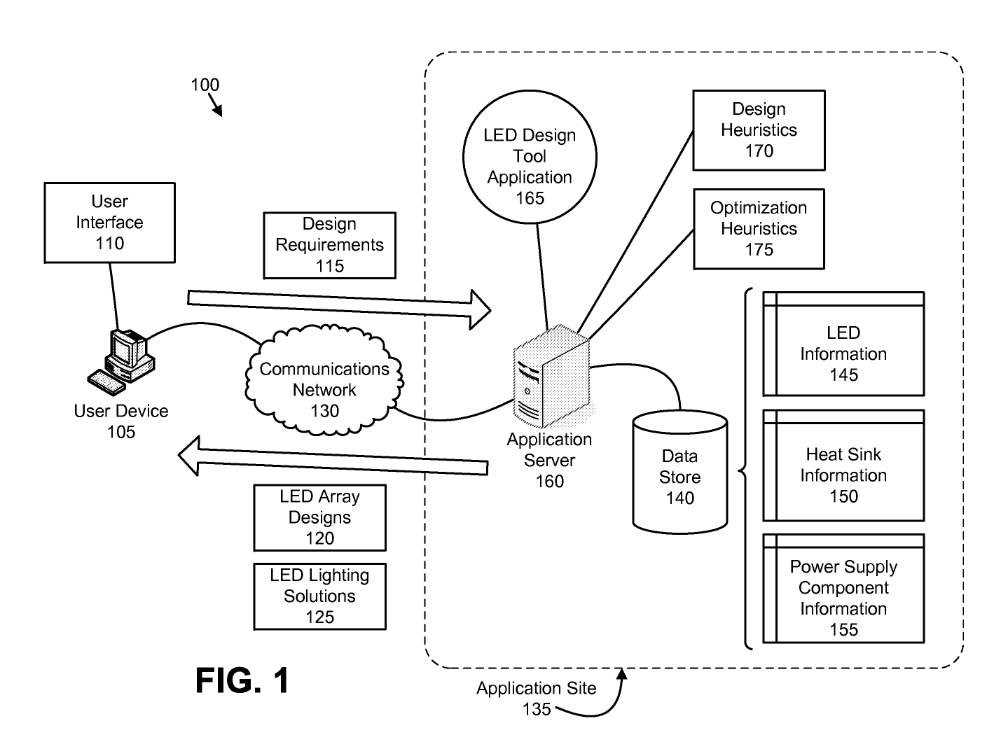

FIG. 1 illustrates an exemplary system 100 for determining LED lighting systems. As illustrated in FIG. 1, the exemplary system 100 includes a user device 105 configured to provide a user interface 110, where the user interface 110 receives a set of design requirements 115 and presents LED array designs 120 responsive to the design requirements 115. The user interface 110 may further present LED lighting solutions 125 responsive to the design requirements 115 and based on one or more LED array designs 120. The system 100 further may include a communications network 130 in selective communication with the user device 105 and an application site 135. The application site 135 includes a data store 140 configured to store LED information 145, heat sink information 150, and LED driver component information 155. The application site 135 further may include an application server 160 configured to run an LED design tool application 165. The LED design tool application 165 receives the design requirements 115, and generates the LED array designs 120 and the LED lighting solutions 125 responsive to the design requirements 115, relevant design heuristics 170 and optimization heuristics 175, as well as selected LED information 145, heat sink information 150, and LED driver component information 155 from the data store 140. System 100 may take many different forms and include multiple and/or alternate components and facilities. While an exemplary system 100 is shown in FIG. 1, the exemplary components illustrated in FIG. 1 are not intended to be limiting. Indeed, additional or alternative components and/or implementations may be used.

The user device 105 may be a device configured to be operated by one or more users, such as a cellular telephone, laptop computer, tablet computing device, personal digital assistant, or desktop computer workstation, among others. The user device 105 may include one or more components capable of receiving input from a user, and providing output to the user.

The user interface 110 may be an interface configured to allow for the effective operation and control of the user device 105. The user interface 110 may further provide feedback and other output to the user to aid the user in making operational decisions with respect to the user device 105. Exemplary user interfaces 110 may include input devices such as keyboards, buttons, and microphones, and output devices such as display screens and loudspeakers. As a particular example, a user interface 110 may be implemented by way of one or more web pages displayed by the user device 105 by way of a web browser software program. Such a web-based user interface 110 may accept input from a user by way of one or more controls on a web page and may provide output by displaying web pages to the user including feedback or other outputs of the system 100. As another example, a user interface 110 may be implemented by way of a self contained rich internet application (RIA) utilizing an engine such as Adobe Flash, where the RIA may accept input from a user by way of one or more controls and provide output that may be viewed by the user on the user device 105.

The design requirements 115 may include information regarding desired LED lighting solutions 125. For example, the design requirements 115 may include an amount of light output for an LED lighting solution 125 specified in lumens. The design requirements 115 may further include an ambient temperature at which the LED lighting solutions 125 may operate, as well as a color, dominant wavelength, or spectrum of light to be produced. The design requirements 115 may also include the minimum and maximum input voltage to the system and whether the input voltage is AC or DC. For white LEDs, the design requirements 115 may include the color temperature or color description such as cool white, neutral white or warm white. Notably, the design requirements 115 do not require specification of a particular part number of LEDs to use, and further do not require specification of a quantity or arrangement of LEDs although provision may be made for the user to enter those parameters if desired and override the automatic selection of these parameters.

The design requirements 115 may further include one or more additional details of the LED designs, such as maximum allowable output voltage for the LED driver; a maximum number of parallel LED strings allowed on one LED driver; maximum X, Y, and Z dimensions of any required heat sink; preference for a specific LED manufacturer; a maximum junction temperature limit to improve LED system reliability and life; a preference for a preferred distributor; a desired LED current; a maximum number of LEDs in series; a maximum number of LEDs in parallel; heat sink options including thermal resistance between the heat sink and air (OsA), heat sink part number, or whether to allow the system to calculate the heat sink automatically; information on custom LEDs to specify to the system including LED forward voltage (V_{f}), maximum LED current, and additional parameters such as variation of light output vs. temperature, variation of light output vs. current, and variation of V_{f} vs. current; optimization settings such as small footprint, high luminous efficacy, and low price; and desired LED lifetime.

The LED array designs 120 may include one or more systems designed to provide an amount of light output able to satisfy a set of design requirements 115. Each LED array design 120 may include a determined quantity of a selected type of LEDs. Each LED array design 120 may further include a heat sink capable of accommodating both the determined quantity of LEDs as well as an expected amount of heat generated by the LEDs. The LED array designs 120 may further account for additional design requirements 115, such as a preference for a specific LED manufacturer; a maximum junction temperature limit to improve LED system reliability and life; and a preference for a preferred distributor.

In some examples one or more aspects of the determined LED array designs 120 may be overridden or customized. Exemplary aspects that may be overridden or customized may include adjustment of the part number of the LED used in the LED array design 120, the number of LEDs used in parallel in the LED array design 120, the number of LEDs used in series in the LED array design 120, the heat sink thermal resistance for the associated heat sink for the LED array design 120 (e.g., measured in degrees Celsius per watt (° C./W)), and/or the maximum current to be provided to the LED array design 120. Modification of these aspects and other aspects of the LED array design 120 accordingly affects the characteristics of the LED array design 120. For example, if the maximum current of an LED array design 120 is modified, then the light output may correspondingly be increased, as may be the heat dissipation. Adjustment of aspects of the LED array designs 120 thus allows the user to modify an existing LED array design 120 or to create a new LED array design 120 as a customized version of an existing LED array design 120.

The LED lighting solutions 125 may include a set of one or more solutions to a set of specified design requirements 115. Each LED lighting solution 125 includes an LED array design 120 as well as an LED driver design designed to receive power from an input source and provide power to the LEDs in the LED array design 120. Particulars of the determination of the LED driver design for the LED lighting solutions 125 are discussed in further detail below.

Differences in the possible LED array designs 120 and LED driver designs may allow the LED lighting solutions 125 to have various combinations of characteristics, such as cost, size, and efficacy. Key parameters are characteristics of the LED array designs 120 and/or LED lighting solutions 125 that may be of particular interest to a user of the system 100. For example, key parameters may include footprint, cost, component count, and efficacy, among others.

The communications network 130 may include a mixture of wired (e.g., fiber and copper) and wireless mechanisms that incorporate related infrastructure and accompanying network elements. Illustrative communication networks 130 may include the Internet, an intranet, the Public Switched Telephone Network (PSTN), and a cellular telephone network. The communications network 130 may include multiple interconnected networks and/or sub-networks that provide communications services, including data transfer and other network services to at least one user device 105 connected to the communications network 130.

The communications network 130 may be in selective communication with an application site 135. The application site 135 may be a hosting platform, such as a web hosting platform, configured to make applications available over the communications network 130. To perform the hosting functions, the application site 135 may include computing devices such as one or more data stores 140 and application servers 160.

The data store 140 may include one or more data storage mediums, devices, or configurations, and may employ various types, forms, and/or combinations of storage media, including but not limited to hard disk drives, flash drives, read-only memory, and random access memory. The data store 140 may include various technologies useful for storing and accessing any suitable type or form of electronic data, which may be referred to as content. Content may include computer-readable data in any form, including, but not limited to video, image, text, document, audio, audiovisual, metadata, and other types of files or data. Content may be stored in a relational format, such as via a relational database management system (RDBMS). As another example, content may be stored in a hierarchical or flat file system.

In particular the data store 140 may store content including LED information 145, heat sink information 150, and LED driver component information 155. Notably, the LED information 145, heat sink information 150, and LED driver component information 155 are information with respect to individual LEDs, heat sinks, and components only, not completed designs, solutions, or formulations. The LED information 145, heat sink information 150, and LED driver component information 155 may be received from manufacturers or suppliers in various forms, such as parts information sheets, parts catalogs, schematics, among others. The received LED information 145, heat sink information 150, and LED driver component information 155 may be formatted and saved into the data store 140 for use in determining the LED lighting solutions 125.

The LED information 145 may include information about one or more LEDs, such as one or more of a manufacturer; a part number; model parameters of the variation of light output vs. temperature; model parameters of the variation of light output vs. current; model parameters of the variation of V_{f} vs. current for each LED; and model parameters of the LED lifetime vs operating temperature. The LED information 145 may further include one or more of a maximum allowed operating current, a maximum allowed operating temperature, and a thermal resistance of the junction to case (Θ_{JC}), among other information.

The heat sink information 150 may include information about one or more heat sinks, such as one or more of a manufacturer; a part number; model parameters of the Θ_{SA} vs. power; model parameters of Θ_{SA} vs. forced air velocity; Θ_{SA} vs. heat sink size in the x dimension for extruded heat sinks; x dimensions for non extruded heat sinks; as well as y and z heat sink dimensions, among other information.

The LED driver component information 155 may include information on individual power supply components, such as power supply regulators (e.g., switching regulators, low drop out regulators (LDOs), switched capacitors or other types of voltage regulators), capacitors, resistors, diodes, etc. Exemplary LED driver component information 155 may include one or more of part cost; whether the part is in stock; part dimensions and footprint; pin configuration; minimum and maximum ranges of operation; light output; heat sink requirements; efficiency/efficacy information; parametric values such as inductance, DC resistance, capacitance, equivalent series resistance, voltage rating current rating, etc.; and graphs of various characteristics of operation, among other exemplary characteristics.

The application site 135 may further include an application server 160. The application server 160 may be implemented as a combination of hardware and software, and may include one or more software applications or processes for causing one or more computer processors to perform the operations of the application server 160 described herein.

An LED design tool application 165 may be one application included on the application server 160, wherein the LED design tool application 165 may be implemented at least in part by instructions stored on one or more computer-readable media. The LED design tool application 165 may include instructions to cause the application server 160 to receive design requirements 115, query the data store 140 for LED information 145, heat sink information 150, and LED driver component information 155 related to the design requirements 115, produce LED array designs 120 and LED lighting solutions 125 responsive to the design requirements 115, LED information 145, heat sink information 150, and LED driver component information 155, and return the LED array designs 120 and LED lighting solutions 125 for display on the user interface 110 as well as for further analysis and use.

The LED design tool application 165 may utilize design heuristics 170 when determining the LED array designs 120 or LED lighting solutions 125 responsive to the design requirements 115. Design heuristics 170 may include rules related to the generation of LED array designs 120 or LED lighting solutions 125. For example, a design heuristic 170 may be utilized to determine groupings of LEDs into one or more strings of LEDs discussed in detail below.

The LED design tool application 165 may utilize optimization heuristics 175 when determining the LED array designs 120 and LED lighting solutions 125 responsive to the design requirements 115. Optimization heuristics 175 may be responsive to key parameters indicative of tradeoffs between various design goals, and may be utilized to prefer one or more key parameters over other key parameters of a design. Design goals to be optimized by optimization heuristics 175 may include small component footprint, efficiency, efficacy, cost, thermal dissipation, and power utilized, among others. As an example, an optimization heuristic 175 for designs with a smaller footprint may optimize for size by choosing LEDs with relatively smaller footprints that still satisfy the design requirements 115, but at the expense of other key parameters such as efficacy. As another example, an optimization heuristic 175 for designs with a higher efficacy may optimize by choosing components having a higher efficiency rating while still satisfying the design requirements 115, but at the expense of other key parameters such as cost.

Computer-executable instructions may be compiled or interpreted from computer programs created using a variety of well known programming languages and/or technologies, including, without limitation, and either alone or in combination, Java™, C, C++, Visual Basic, Java Script, Perl, PL/SQL, etc. The LED design tool application 165 may accordingly be written at least in part according to a number of these and other programming languages and technologies, or a combination thereof.

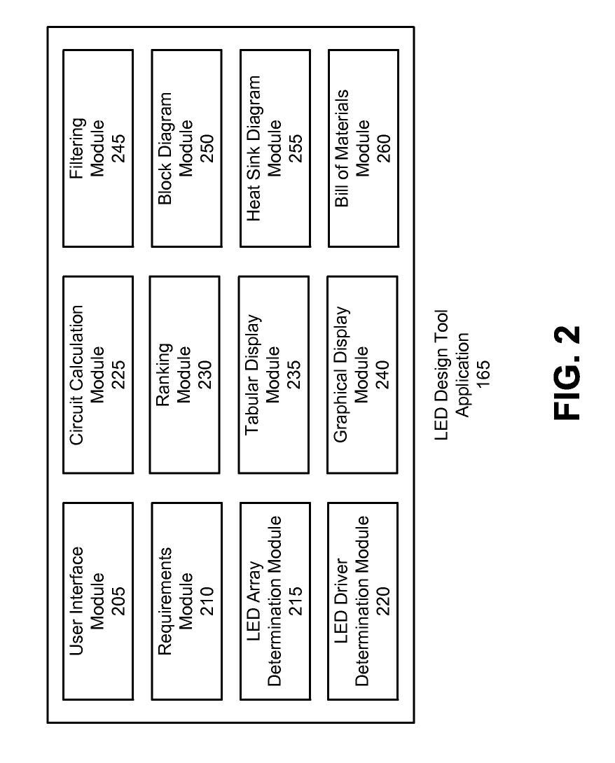

In some instances, the LED design tool application 165 is provided as software that when executed by a processor of the application server 160 provides the operations described herein. Alternatively the LED design tool application 165 may be provided as hardware or firmware, or combinations of software, hardware and/or firmware. An exemplary modularization of the LED design tool application 165 is discussed in further detail below with respect to FIG. 2.

In general, computing systems and/or devices, such as user device 105, application server 160, and data store 140 may employ any of a number of well known computer operating systems, including, but by no means limited to, known versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other known computing system and/or device.

Computing devices, such as data store 140 and application server 160 generally include computer-executable instructions, where the instructions may be executable by one or more computing devices such as those listed above. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores, such as such as data store 140 described herein, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

While FIG. 1 illustrates an exemplary system 100, other implementations may be used. In some implementations, the system 100 may be implemented as an off-line or self-contained computing device based configuration. In such an implementation, the application server 160 and LED design tool application 165 may be implemented by a back-end calculation engine running on the computing device. In some implementations, the LED design tool application 165 may be executed by way of a self-contained RIA utilizing an engine such as Adobe Flash. For example, the RIA may be downloaded by a client from a server by way of a network such as the Internet or an intranet, and where most or substantially all of the calculations performed by the system 100 may be performed on the client using the RIA, without need to go back to the server again during a design session.

Further, in some implementations additional elements may be included or elements shown in FIG. 1 may be omitted or modified. For example, one or more of the user device 105, data store 140, and application server 160 may be combined in certain implementations. As another example, a system may include multiple data stores 140 and/or application servers 160. In still further examples, LED design tool application 165 may be implemented across multiple application servers 160. While communications network 130 is shown in the illustrated embodiment, in other embodiments the communications network 130 may be omitted entirely and the user device 105 may be connected directly to the application site 135. In still other examples, the LED design tool application 165 may be executed in whole or in part by the user device 105.

FIG. 2 illustrates an exemplary modularization of the LED design tool application 165. As shown in the Figure, the LED design tool application 165 may include a user interface module 205, a requirements module 210, an LED array determination module 215, an LED driver determination module 220, a circuit calculation module 225, a ranking module 230, a tabular display module 235, a graphical display module 240, a filtering module 245, a block diagram module 250, a heat sink diagram module 255, and a bill of materials module 260. The LED design tool application 165 and its components 205-260 may be provided as software that when executed by a processor provides the operations described herein. Alternatively, the LED design tool application 165 and its components 205-260 may be provided as hardware or firmware, or combinations of software, hardware and/or firmware. Although one example of the modularization of the LED design tool application 165 is illustrated and described, it should be understood that the operations thereof may be provided by fewer, greater, or differently named modules.

The user interface module 205 may be configured to provide the user interface 110 to be displayed by way of the user device 105. For example, the user interface module 205 may be implemented by way of one or more web pages configured to accept the design requirements 115 from a user and provide output to the user including LED array designs 120. The user interface module 205 may be implemented using technologies such as Java, AJAX, Adobe Flex, Adobe Flash, Microsoft.NET, among others. The user interface module 205 may be configured to generate web pages via the application server 160 to be transmitted to the user device 105 via the communications network 130. These web pages may then be viewed by the user on the user device 105 using a web browser program.

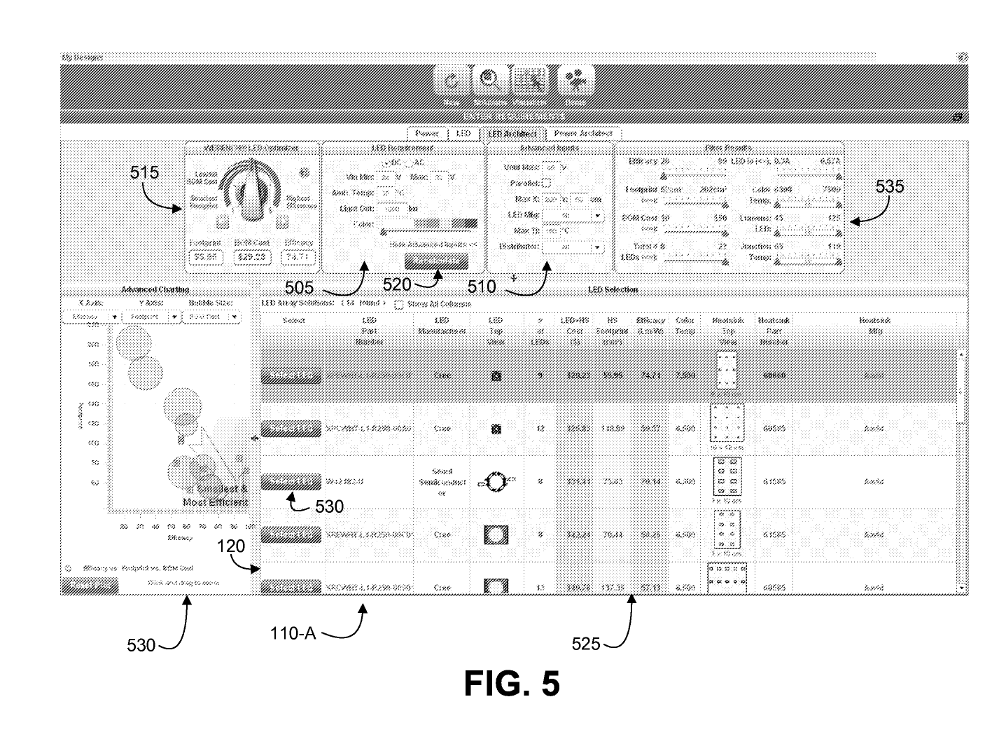

Exemplary user interfaces 110 allowing for the specification of design requirements 115 and the viewing of LED array designs 120 are illustrated with respect to FIGS. 5-9 described below. It should be noted that the while specific user interfaces 110 are illustrated in the exemplary Figures, the user interfaces 110 presented by the LED design tool application 165 by way of the user interface module 205 may vary from implementation to implementation.

The requirements module 210 may be configured to utilize the user interface module 205 to allow the user of the user device 105 to specify design requirements 115 for the LED array designs 120. For example, the requirements module 210 may be configured to allow a user to specify design requirements 115 including one or more of an amount of light output; an ambient temperature; an LED color; minimum and maximum input voltage; whether the input voltage is AC or DC; a maximum allowed output voltage for the LED driver; a maximum number of parallel LED strings allowed on one LED driver; maximum X, Y, and Z dimensions of any required heat sink; a specific LED manufacturer; a maximum junction temperature limit to improve LED system reliability and life; a preferred distributor; a desired LED current; a number of LEDs in series; a number of LEDs in parallel; heat sink options including thermal resistance between the heat sink and air (Θ_{SA}), heat sink part number, or to have software calculate the heat sink automatically (default behavior); information on custom LEDs to specify to the system including LED forward voltage (V_{f}), maximum LED current, and additional parameters such as variation of light output vs. temperature, variation of light output vs. current, and variation of V_{f} vs. current; and desired LED lifetime. Generally, light output increases vs. current, light output decreases vs. temperature, efficacy decreases vs. current, and V_{f} increases vs. current.

The requirements module 210 may further be configured to allow the user to specify a tradeoff between various design goals for the generated LED array designs 120 and/or LED lighting solutions 125. Exemplary design goals may include small footprint, a high luminous efficacy, a low cost, or a long LED lifetime. In some examples, through use of the user interface module 205, the requirements module 210 may present a knob control to the user to allow for the selection of a tradeoff between the various design goals. For example, the knob may provide for the selection of high efficacy over a small footprint, or for low cost over high efficacy. These tradeoffs between various design goals may be included as parameters of the design requirements 115.

The requirements module 210 may further be configured to utilize the user interface module 205 to provide a control for selection once the design requirements 115 have been specified. Upon receiving indication of selection of the control, the requirements module 210 may indicate to the LED design tool application 165 that the design requirements 115 have been entered and that the LED array designs 120 should be determined. The user may also select the user interface element after modifying one or more design requirements 115, to indicate to the LED design tool application 165 that new LED array designs 120 should be determined.

The LED array determination module 215 may be configured to determine LED array designs 120 based on design requirements 115, such as the design requirements 115 received by the requirements module 210.

Using the design requirements 115, the LED array determination module 215 may be configured to query the data store 140 for LED information 145 responsive to the design requirements 115, and to retrieve the LED information 145 from the data store 140. The retrieved LED information 145 may include information on types of LEDs that may be usable in the generation of LED array designs 120.

Using the retrieved LED information 145, the LED array determination module 215 may determine a set of candidate LEDs that may be usable for LED array designs 120 in accordance with the design requirements 115. Some LEDs may be determined as being unsuitable candidates for any design. For example, such an LED may draw more current than is available, or may provide light in a spectrum of colors other than those included in the design requirements 115. Other LEDs may be determined as being unsuitable as failing to meet with the desired optimizations. For example, an optimization heuristic 175 configured to prefer a small footprint may select a threshold number of the smallest LEDs, excluding the larger LED parts. The remaining LEDs may be determined to be candidate LEDs for use in LED array designs 120.

For each type of candidate LED, the LED array determination module 215 may be configured to determine a best LED operating current for the LED type to achieve the design requirements 115 for footprint, luminous efficacy, and cost; number of the LEDs of that type required to generate the desired amount of light as well as parameters of a heat sink required to keep the temperature within the operating limits of the type of LED or to achieve the desired LED lifetime. The LED array determination module 215 may perform these calculations based on the modeled parameters of the LEDs. For example, an optimization heuristic 175 configured to prefer a high efficacy LED system may lower the current and also specify a lower heat sink Θ_{SA} value, which provides better cooling, since most LEDs have higher efficacy at lower current and lower temperature.

The LED array determination module 215 may further be configured to determine one or more possible heat sinks for each candidate LED. To determine a proper heat sink, the LED array determination module 215 may further be configured to retrieve heat sink information 150 from the data store 140. For each candidate heat sink that is returned, the LED array determination module 215 may be configured to determine a Θ_{SA} value for the heat sink, based on design requirements 115 such as ambient temperature, the candidate LED power dissipation, the maximum specified heat sink size, and modeled parameters in the database regarding the heat sinks. Accordingly, for each candidate LED, the LED array determination module 215 may be configured to select one or more heat sinks from the heat sink information 150 capable of satisfying the Θ_{SA} value for the heat sink as well as capable of holding the requisite number of LEDs having the dimensions of the candidate LED.

In some instances the LED array determination module 215 may select one best heat sink out of the heat sinks capable of satisfying the design requirements 115, such as by selecting the heat sink best able to satisfy any design requirements 115 including any requested optimizations. In other instances, the LED array determination module 215 returns multiple possible heat sinks, to allow the user more options for optimizing the LED array design 120, or to allow different heat sinks with a given LED array to be displayed to the user.

The LED array determination module 215 may accordingly determine a plurality of LED array designs 120, each including a number of LEDs of a particular type required to generate the desired amount of light, and a heat sink capable of accommodating both the determined quantity of LEDs as well as the expected amount of heat generated by the LEDs.

The LED driver determination module 220 may be configured to determine a variety of LED driver designs appropriate to power one or more LED array designs 120. The LED driver determination module 220 may receive one of LED array designs 120, such as the LED array designs 120 determined by the LED array determination module 215. Based on each LED array design 120, the LED driver determination module 220 may determine one or more LED drivers capable of powering the particular LED array design 120. In some instances, the LED driver determination module 220 may determine a single LED driver capable of powering the entire LED array design 120. In other instances, the LED driver determination module 220 may determine multiple LED drivers that are each configured to power a portion of the LEDs in the LED array design 120. In some cases, the LED driver determination module 220 may determine multiple alternate LED driver designs that each may be used to power the LED array design 120.

An exemplary algorithm that may be used by the LED driver determination module 220 to determine the LED lighting solutions 125 may include checking to see if any LED drivers can power the entire number of LEDs in a series arrangement, (i.e., with all the LEDs in the design connected end to end in one string). This may require a high output voltage since the V_{f} of the total LED string is the sum of the V_{f} of each LED. Such a scenario may cause the LED driver determination module 220 to select drivers which can do boost topology if the total LED string voltage exceeds the maximum input voltage specified in the design requirements 115.

For example, for an array of 24 LEDs, each of which has a 3V V_{f}, is being run at 0.5 A current (I_{O}), the total V_{f} would be approximately 72V (plus a small contribution from the current sense resistor) and the total current would be 0.5 A if the LEDs are arranged in a single series string. If the input voltage range were 20V to 40V, then this situation may require a boost topology since the output voltage of approximately 72V is greater than the maximum input voltage of 40V.

In any event once the LED driver determination module 220 calculates the total V_{f} and I_{O}, the exemplary algorithm may further include inputting these parameters and the input voltage for each LED driver into a circuit calculation module 225. An exemplary circuit calculation module 225 is the WEBENCH circuit calculation engine provided by National Semiconductor. The circuit calculation module 225 may accordingly attempt to create an LED driver design for each LED driver. LED drivers may be disqualified if certain criteria are not met, for example if the input voltage is too high, the output current is too high, the output voltage is too high or low, the duty cycle is out of specification, or if suitable passive components such as a metal-oxide-semiconductor field-effect transistor (MOSFET) cannot be found which meets the design requirements 115 or other requirements of the design.

The LED driver determination module 220 may further be configured to divide the strings of LEDs into two or more parallel strings and check to see if any LED drivers can power this array. Splitting the LED array into multiple parallel strings has the benefit of lowering the overall string voltage, which may allow for buck/boost or buck driver topologies. However, such a topology may increase the number of drivers required if the user has selected the no parallel string per driver option, or may increase the current on each driver if the user has allowed the parallel string per driver option.

Continuing with the example of an array of 24 LEDs, each with a 3V V_{f}, and 0.5 A I_{O}, if the LEDs are arranged into two parallel strings, the V_{f} of the array would be approximately (24*3)/2=36V (plus a small contribution from the current sense resistor). The current would accordingly be 1*I_{O}=0.5 A if two LED drivers are used or 2*I_{O}=1 A if only one LED driver is used. If the input voltage range were 20V to 40V, then this situation may require a buck/boost, flyback or single-ended primary-inductor converter (SEPIC) topology since the output voltage of 36V falls between the minimum and maximum input voltage. The circuit calculation module 225 may be used to find suitable LED drivers which will support this arrangement of LEDs, similar to as described above.

The LED driver determination module 220 may further be configured to divide the strings of LEDs into larger numbers of parallel strings, such that the total V_{f} of each string is less than the minimum input voltage specified in the design requirements 115. In some examples, this determination may further account for an extra “dropout” voltage due to estimated voltage losses in the LED driver switching circuit. The LED driver determination module 220 may further be configured to check to see if any LED drivers can power this array. This allows for the possibility of buck topology being used for the LED driver which may be less costly, simpler to use and smaller than the other topologies. But, such as topology may require additional LED drivers if no parallel strings are allowed per LED driver or may require larger current for each LED driver if parallel strings are allowed on each LED driver.

For example, continuing with the example of an array of 24 LEDs, each with a 3V V_{f}, and 0.5 A I_{O}, if the LEDs are arranged in four parallel strings, the V_{f} would be (24*3)/4=18V. The current would be 1*I_{O}=0.5 A if four LED drivers are used or 4*I_{O}=2A if only one LED driver is used. If the input voltage range were 20V to 40V, then this situation may allow a buck topology to be used since the output voltage of 18V is lower than the minimum input voltage, but the driver would need to be able to handle the 2A current requirement if parallel LEDs per driver were allowed. The circuit calculation module 225 may be used to find suitable LED drivers which will support this arrangement of LEDs, similar to as described above.

The LED driver determination module 220 may further be configured to test other series and parallel arrangements of LEDs to see if any LED drivers may power the additional arrangements of the LEDs while achieving better optimizations, such as a smaller footprint, a lower cost, or a higher luminous efficacy.

In some instances it may not be possible to evenly divide a number of LEDs in an LED array design 120 to obtain strings of LEDs each having the same number of LEDs. In these instances, the LED driver determination module 220 may further be configured to increase the number of LEDs in the LED array design 120 and decrease the amount of current (or reduce the number of LEDs and increase the current to) keep the amount of light constant. For example, if the number of LEDs is 23, this number cannot be evenly divided into two strings with the same number of LEDs. Accordingly, the number of LEDs may be increased to 24, which may be divided into two strings of 12. The current would accordingly be lowered to keep the light output for the array of 24 LEDs constant with that of the 23 LED array.

As another possibility, in instances where it is not possible to evenly divide a number of LEDs, the LED driver determination module 220 may be configured to divide the LEDs into strings with different numbers of LEDs in each string. For example, for 23 LEDs, the LEDs may be divided up into one string that has 12 LEDs and another string that has 11 LEDs. This may require different drivers to be used for each LED, which may lead to additional design complexity and possible differences in light output for each LED string due to mismatches in the performance of the LED drivers. However, such an approach keeps the number of LEDs down, which may lower the cost of the overall design, including the LED array design 120 and the LED drivers, compared to options in which one or more additional LEDs are added to evenly match the LED strings.

The footprint of the LED array may be determined by the heat sink footprint if it is greater than the area of the LEDs themselves, which is typical. If the heat sink is smaller than the LEDs, then the footprint may be determined by the area of the LEDs which would be mounted on a PC board which could be larger than the heat sink. For the LED driver(s), the footprint may be determined from the footprint of all the components used in the driver design including the voltage regulator, the inductor, diode, MOSFET, capacitors, etc. The types of components used may differ depending on the topology and voltage regulator used.

In some examples, the requirements module 210 in combination with the LED array determination module 215 and/or LED driver determination module 220 may further be configured to allow for customization of determined LED array designs 120 and/or LED lighting solutions 125. Merely by way of example, aforementioned modules may allow for adjustment one or more of a part number of the LED used in the LED array design 120, the number of LEDs used in parallel in the LED array design 120, the number of LEDs used in series in the LED array design 120, the heat sink thermal resistance for the associated heat sink for the LED array design 120, and/or the maximum current to be provided to the LED array design 120, among other possible customizations.

Once all the potential LED drivers are determined by the LED driver determination module 220, these options may be sorted using a ranking module 230. The ranking module 230 may sort the LED lighting solutions 125, LED array designs 120 and/or LED drivers utilizing a weighted scoring technique. For example, a design requirement 115 may indicate a preference for LED lighting solutions 125 having high efficacy. Accordingly, based on such a design requirement 115, the ranking module 230 may rank at least a portion of the LED lighting solutions 125 according to efficacy as determined by the circuit calculation module 225.

The ranking module 230 may further determine a ranking while accounting for multiple variables simultaneously. For example, the ranking module 230 may use an algorithm in which a target value is set for one or more parameters of an LED lighting solution 125. The closer a parameter of a LED lighting solution 125 is to the corresponding target, the higher the initial score for that parameter. A weight may also be assigned to each parameter. A final score for each LED lighting solution 125 further may be determined based on the initial score and the weight (e.g., as a product of the score and weight values). For example, if two parameters with a same deviation from a target value have different weights, the one with the higher weight would receive a higher overall score. Accordingly, the weighted scoring algorithm may allow for ranking of LED lighting solution 125, taking into account multiple parameters at once.

The tabular display module 235 may be configured to utilize the user interface module 205 to present a set of data in a tabular fashion, including key parameters of items in the set of data. The tabular display module 235 may further be configured to provide for sorting and selection of the included data items.

For example, the tabular display module 235 may be configured to display the LED array designs 120 to the user in a tabular form. The key parameters of the LED array designs 120 may include the number of LEDs for each LED array design 120, part number and manufacturer of the LEDs and heat sinks, LED and heat sink cost, LED luminous efficacy, footprint area of the heat sink, and color temperature or dominant wavelength of the LEDs, among other key parameters. The tabular display module 235 may further be configured to present a scaled top view image of the LEDs arrayed onto the heat sink with the heat sink size, and a top view image of the LEDs.

The tabular display module 235 may also be configured to provide additional parameters of the data to be displayed. Continuing with the example of LED array designs 120, the tabular display module 235 may provide one or more of individual LED cost, V_{f} of each LED, LED junction temperature, heat sink cost, heat sink height, LED light emission angle, heat sink Θ_{SA}, and light output per LED, among other parameters. In some instances the additional parameters are included by the tabular display module 235 in the data to display upon selection of a control on the user interface 110 indicating that additional parameters of the LED array design 120 should be displayed.

As another example, the tabular display module 235 may be configured to display a table of choices for LED lighting solutions 125, listing various key parameters of the LED lighting solutions 125. These parameters may include the LED driver part number, total number of LED drivers required, system footprint, system bill of materials (BOM) cost, system efficacy and system component count, among others. The tabular display module 235 may further be configured to include details about the LED lighting solution 125, such as a thumbnail view of the schematic and BOM components, the driver efficiency, efficacy, topology (such as boost, buck, etc.), number of LEDs in series and parallel per driver, total Vout, and total Iout, among other details.

The tabular display module 235 may further be configured to optionally show additional parameters of the LED lighting solution 125, such as driver BOM footprint, driver BOM cost, LED array cost, LED and heat sink combined footprint, LED efficacy, V_{f} and I_{O} for each LED, LED junction temperature, system efficiency, system efficacy, driver BOM count, light output per LED, among other exemplary parameters. The tabular display module 235 may allow for the selective inclusion of these additional parameters upon selection of a control presented by user interface module 205 indicating a request by the user to view the additional information. The values in the table may be arranged to show the best results at the top, such as through use of the ranking module 230.

The graphical display module 240 may be configured to utilize the user interface module 205 to present a set of data in a graphical format. The graphical display module 240 may also be configured to provide for the representation of different key parameters of the data as well as the selection of the displayed data items. The graphical display module 240 may be useful in representing the tradeoffs between items in the set of data by representing various key parameters of the items as the X and Y axes of the graph. The graphical display module 240 may further represent the points within the graph as items of varying size and/or color to indicate a third key parameter as a third dimension. Thus, the graph can contain more than two dimensions by using circles of different diameters for each data point to signify larger or smaller values and/or different colors to represent differences in the values being plotted.

For example, the graphical display module 240 may be configured to present the LED array designs 120 to the user in the form of a graph. The graphical display module 240 may represent the tradeoffs between the various LED array designs 120 by representing various key parameters of the LED array designs 120 as the X and Y axes of the graph as well as by the point size and/or color within the graph. As one possibility, the axes may default to system footprint and luminous efficacy, with a circle around each data point of variable size to represent the BOM cost for the LEDs and heat sink. The size of the circle may accordingly vary in size to become larger for a higher BOM cost and smaller for a lower BOM cost. The graphical display module 240 may be configured to allow a user to configure the axes of the graph, allowing the user to visualize other parameters in the design such as BOM count, among others.

The graphical display module 240 may further be configured to display a graph of choices for the LED lighting solutions 125, utilizing various key parameters for the axes of the graph. Similar to as discussed above, the axes may default to system footprint and luminous efficacy with a circle around the data point of variable size to represent the BOM cost. The graphical display module 240 may be configured to allow a user to configure the axes of the graph, allowing the user to visualize other parameters in the LED lighting solutions 125 such as BOM count, among others.

The filtering module 245 may be configured to allow for the filtering of data elements displayed in the tabular display module 235 and graphical display module 240. The filtering module 245 may further be configured to utilize the user interface module 205 to provide slider controls, check boxes and other controls in the user interface 110 to allow a user of the user device 105 to narrow down a list of displayed items.

For example, the filter module 245 may be configured to allow for the filtering of LED array design 120 and/or LED lighting solutions 125 displayed by the tabular display module 235 and graphical display module 240. Exemplary filter criteria for the LED array designs 120 and/or LED lighting solutions 125 may include minimum luminous efficacy, maximum footprint, maximum BOM cost, maximum number of LEDs, maximum LED current (I_{O}), color temperature range, luminous flux output per LED, and junction temperature, among other criteria.

The block diagram module 250 may be configured to depict a diagram of a selected LED lighting solution 125, including both the LED array design 120 and the LED driver design. In particular, the block diagram module 250 may illustrate the LEDs connected in the calculated series and parallel arrangement, the one or more LED drivers required to power the LED array, and the connections between the LEDs and LED drivers to allow the user to understand how these elements are to be hooked together. The block diagram module 250 may further include a control to allow the user to zoom in and out of the illustrated diagram.

The heat sink diagram module 255 may be configured to display a graphical depiction of the LEDs arranged on the determined heat sink. In some instances, the LEDs and heat sinks may be displayed in the same scale relative to one another to allow the user to better understand the layout. In some instances the heat sink diagram module 255 may further include a control to allow the user to zoom in and out of the illustrated depiction.

The bill of materials module 260 may be configured to determine a BOM including the list of parts used for each of the LED lighting solutions 125. The bill of materials module 260 may further determine a total cost of the design and a total number of components for the design. To determine the total cost, the bill of materials module 260 may utilize information previously queried from the data store 140 for LED information 145, heat sink information 150, and LED driver component information 155 related to pricing of the utilized LEDs, heat sinks, and components. The bill of materials module 260 may retrieve the pricing information, and may determine an overall cost of the design based on a total sum of the cost of each utilized component. The bill of materials module 260 may further determine a total component count for the design by summing the number of LEDs, heat sinks, and components of each of the LED drivers.

Based on the information presented to the user in the user interface 110, the user may select an LED lighting solution 125, and thus utilize the LED design tool application 165 to determine an LED lighting solution 125 responsive to the design requirements 115.

As described above, the LED design tool application 165 may provide for the selection of an LED array design 120 and then for the selection of an LED lighting solution 125 including the LED array design 120 as two discrete steps. While the user may perform these two selections, the LED design tool application 165 may in fact determine the LED lighting solution 125 for each LED array design 120 all at once. This allows for additional benefit of using only a single interaction with an application server 160 and only one set of accesses to the data store 140, the LED design tool application 165.

Further, in other examples the LED design tool application 165 may combine both of these selections into one, thus allowing for the selection of a LED array design 120 and accompanying LED driver designs in a single step. This combined approach has the advantage of presenting the total solution footprint, luminous efficacy and cost for the combined LED/heat sink/driver without having to iterate back and forth if several different LEDs are being considered. Further, the combined selection approach also has the additional benefit of using only a single interaction with an application server 160 and only one set of accesses to the data store 140. If both steps are combined, then the results may be filtered to only show the best driver solution or solutions for each LED array design 120. The best driver solution or solutions may be determined based on the user's preference for small footprint, low BOM cost and/or high efficacy.

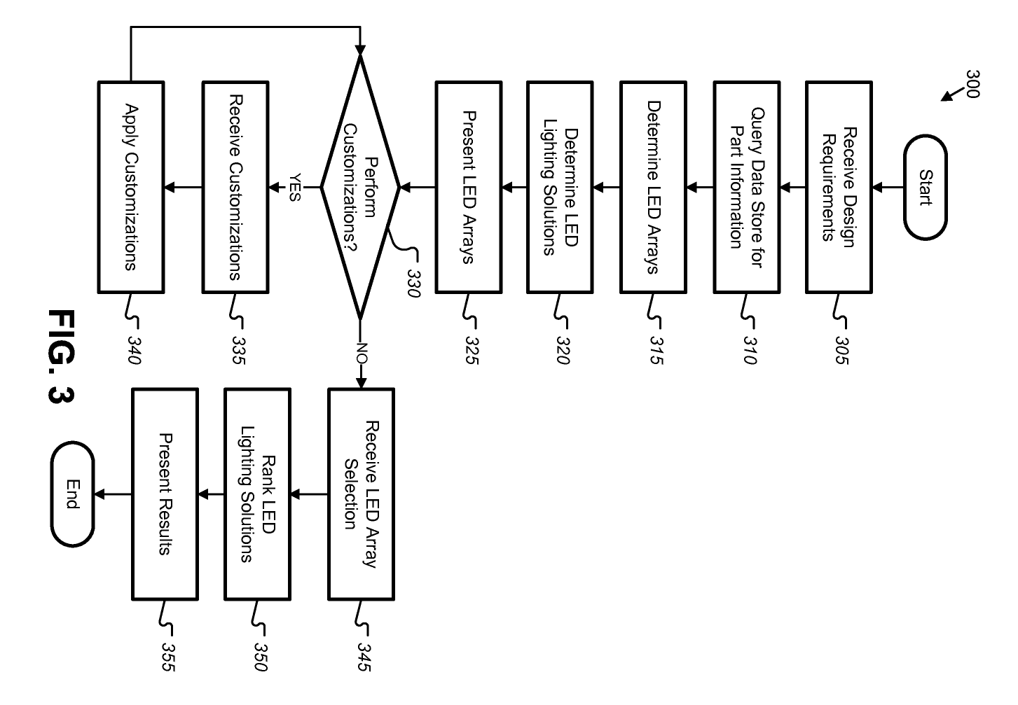

FIG. 3 illustrates an exemplary process flow 300 for the determination of LED lighting solutions 125. The process 300 may be performed by various systems, such as the system 100 described above with respect to FIG. 1.

In block 305, the LED design tool application 165 receives design requirements 115 from a user device 105. For example, a communications network 130 may be in selective communication with a user device 105 and an application site 135. The application site 135 may serve as a hosting platform for an application server 160 running the LED design tool application 165. A user interface module 205 and a requirements module 210 of the LED design tool application 165 may be configured to provide a user interface 110 to a user device 105, such as a web page, where the user interface 110 may allow the user of the user device 105 to specify the design requirements 115 for the LED array designs 120. These design requirements 115 may include an amount of light output for the system, an ambient temperature, and a color, dominant wavelength, or spectrum of light to be produced. The design requirements 115 may also include the minimum and maximum input voltage to the system and whether the input voltage is AC or DC. For white LEDs the design requirements 115 may include the color temperature or color description such as cool white, neutral white or warm white. The design requirements 115 may further include parameters indicative of a tradeoff between various design goals, such as parameters indicative of a preference for one or more of a small footprint, a high luminous efficacy, a low cost, or a long LED lifetime.

In block 310, the LED design tool application 165 queries the data store 140 for part information. For example, using the design requirements 115, the LED array determination module 215 may be configured to query the data store 140 for LED information 145 responsive to the design requirements 115, and to retrieve the LED information 145 from the data store 140. The retrieved LED information 145 may include information on types of LEDs that may be usable in the generation of LED array designs 120. To determine a proper heat sink, the LED array determination module 215 may further be configured to retrieve heat sink information 150 from the data store 140. The LED design tool application 165 further may include instructions to cause the application server 160 to query the data store 140 for LED driver component information 155 related to the design requirements 115.

In block 315, the LED design tool application 165 determines LED array designs 120 based on the design requirements 115, LED information 145, and heat sink information 150. For example, based on the amount of light output, ambient temperature, and color or spectrum of light specified by the design requirements 115, the LED design tool application 165 may utilize an LED array determination module 215 to determine a variety of different LED array designs 120 that may be appropriate to produce the desired light output.

In block 320, the LED driver determination module 220 determines a variety of LED lighting solutions 125 including LED drivers appropriate to power the LED array designs 120. The LED design tool application 165 may utilize an LED driver determination module 220 to arrange the LEDs from the LED array design 120 into one or more strings of LEDs in series and/or parallel configurations, where each string of LEDs is powered by an LED driver. In some instances, the LED driver determination module 220 may further be configured to increase the number of LEDs in the LED array design 120 and decrease the amount of current or reduce the number of LEDs and increase the current to keep the amount of light constant while allowing for easier division of the LEDs into strings of equal length. The LED design tool application 165 may accordingly determine LED lighting solutions 125 including the LED array design 120 as well as one or more LED drivers capable of powering the LED array design 120.

In block 325, the LED design tool application 165 presents the LED array designs 120 to the user. For example, the LED design tool application 165 may utilize a tabular display module 235 to display a table of the LED array designs 120 according to key parameters of the LED array designs 120, where each row in the table indicates a particular LED array design 120 and associated values. The LED design tool application 165 may also utilize a graphical display module 240 to provide a graph of the determined LED array designs 120 representing tradeoffs between the various LED array designs 120 according to key parameters.

In decision point 330, the LED design tool application 165 determines whether to apply any customizations to an LED array design 120 or LED lighting solutions 125. For example, using the user interface module 205, the user may indicate to the LED design tool application 165 that one of the LED array designs 120 is to be customized. If no customizations are to be applied, block 345 is executed next. If customizations are to be applied, block 335 is executed next.

In block 335, the LED design tool application 165 receives any customizations to be applied to the LED array design 120 or LED lighting solutions 125 to be customized. For example, using the requirements module 210 the user may adjust one or more aspects of the LED array design 120 or LED lighting solutions 125, such as a part number of the LED, the number of LEDs used in parallel, the number of LEDs used in series, the heat sink thermal resistance for the associated heat sink, and/or the maximum current to be provided, among other possibilities.

In block 340, the LED design tool application 165 customizes the LED array design 120 or LED lighting solution 125 according to the received customizations. For example, additional aspects of the customized LED array design 120 may be updated in accordance with the change. In some instances, the heat sink used in the LEDs array design 120 may be updated to a heat sink that can accommodate an updated number of LEDs.

In block 345, the LED design tool application 165 receives a selection of a LED array design 120 to be powered. For example, using the user interface module 205, the user may select of one of the LED array designs 120. Selection of one of the LED array designs 120 may allow for the selective display of the LED lighting solutions 125 determined in block 340 including the selected LED array design 120.

In block 350, the LED design tool application 165 ranks the determined LED lighting solutions 125. The LED design tool application 165 may utilize a ranking module 230 to sort the LED lighting solutions 125 including the selected LED array design 120 by way of a weighted scoring technique. For example, a design requirement 115 may indicate a preference for LED lighting solutions 125 having high efficacy. Accordingly, based on such a design requirement 115, the ranking module 230 may rank the LED lighting solutions 125 according to efficacy as determined by the circuit calculation module 225. In some instances, the ranking module 230 may further determine a ranking for the LED lighting solutions 125 accounting for multiple variables simultaneously.

In block 355, the LED design tool application 165 presents the LED lighting solutions 125 to the user, including the LED drivers capable of powering the selected LED array design 120. For example, the LED design tool application 165 may utilize the tabular display module 235 to display a table of LED lighting solutions 125 and key parameters, with each row in the table indicating a particular LED lighting solution 125 and associated values. The LED design tool application 165 may also utilize a graphical display module 240 to provide a graph of the determined LED lighting solutions 125 representing tradeoffs between the various LED lighting solutions 125 according to key parameters. From these listed LED lighting solutions 125, a user may accordingly select a LED lighting solution 125 according to the user's design requirements 115. After block 355, the process 300 ends.

After the user selects a desired LED lighting solution 125, a design may be created on the server or local PC. Then, using the created design, the user may access additional attributes and features such as those available from within the WEBENCH Design Tool provided by National Semiconductor. These attributes about the design may include the full BOM including vendor and part numbers, the schematic, operating values such as currents, power dissipation, switching frequency, IC and component temperature, phase margin and crossover frequency, and other calculated values. The user can also change BOM components, run electrical and thermal simulations, receive a prototype kit, download CAD files, etc.

It should be noted that in some examples, one or more blocks or decision points of the process 300 may be executed concurrently or in an order differing from that illustrated in FIG. 3. As an example, blocks 330, 335, and 340 may be executed in some examples after block 355.

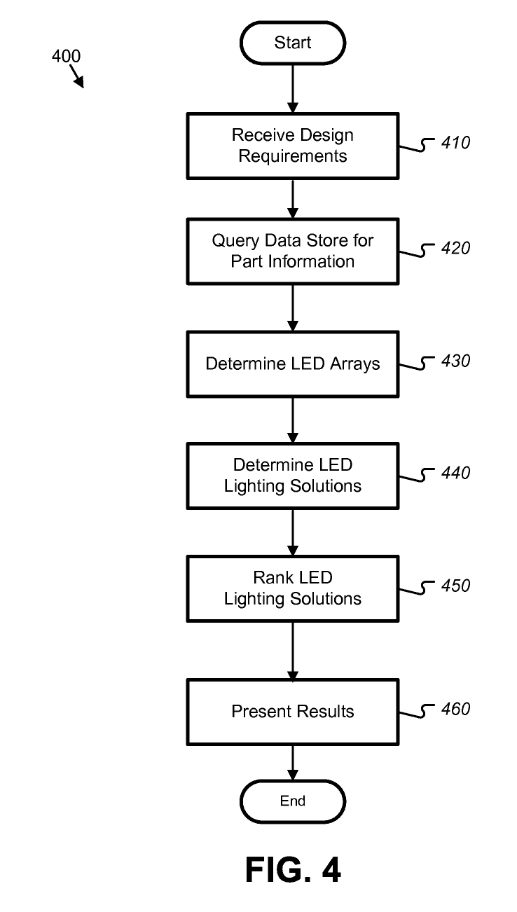

FIG. 4 illustrates an alternate exemplary process flow 400 for the determination of LED lighting solutions 125. However, compared to the process 300, the exemplary process 400 presents the LED lighting solutions 125 using only a single interaction with the user. As with the process 300, the process 400 may be performed by various systems, such as the system 100 described above with respect to FIG. 1.

In block 410, the LED design tool application 165 receives design requirements 115 from a user. Similar to as discussed above with respect to block 305 of process 300, a user interface module 205 and a requirements module 210 of the LED design tool application 165 may be configured to provide a user interface 110 to a user device 105, such as a web page, where the user interface 110 may allow the user of the user device 105 to specify the design requirements 115 for LED lighting solutions 125. These design requirements 115 may include an amount of light output for the system, an ambient temperature, a color, dominant wavelength, or spectrum of light to be produced, and characteristics of an input voltage source, such as minimum and maximum input voltage and whether the input voltage is AC or DC. For white LEDs the design requirements 115 may include the color temperature or color description such as cool white, neutral white or warm white. The design requirements 115 may further include parameters indicative of a tradeoff between various design goals, such as parameters indicative of a preference for one or more of a small footprint, a high luminous efficacy, a low cost, or a long LED lifetime.

In block 420, the LED design tool application 165 queries the data store 140 for part information. Similar to as discussed above with respect to block 310 of process 300, the LED array determination module 215 may be configured to query the data store 140 for LED information 145 responsive to the design requirements 115, and to retrieve the LED information 145 from the data store 140. The retrieved LED information 145 may include information on types of LEDs that may be usable in the generation of LED array designs 120. To determine a proper heat sink, the LED array determination module 215 may further be configured to retrieve heat sink information 150 from the data store 140. The LED design tool application 165 further may include instructions to cause the application server 160 to query the data store 140 for LED driver component information 155 related to the design requirements 115.

In block 430, the LED design tool application 165 determines LED array designs 120 based on the design requirements 115, LED information 145, and heat sink information 150. Similar to as discussed above with respect to block 315 of process 300, based on the amount of light output, ambient temperature, and color or spectrum of light specified by the design requirements 115, the LED design tool application 165 may utilize an LED array determination module 215 to determine a variety of different LED array designs 120 that may be appropriate to produce the desired light output.

In block 440, the LED design tool application 165 determines LED driver solutions for at least a subset of the determined LED array designs 120. Similar to as discussed above with respect to block 320 of process 300 in which LED driver designs are determined for a selected LED array design 120, the LED design tool application 165 may determine LED driver designs for each of the determined LED array designs 120, and therefore determine a variety of LED lighting solutions 125.

In block 450, the LED design tool application 165 ranks the determined LED lighting solutions 125. Similar to as discussed above with respect to block 350 of process 300, the LED design tool application 165 may utilize a ranking module 230 to sort the LED lighting solutions 125 by way of a weighted scoring technique. For example, a design requirement 115 may indicate a preference for LED lighting solutions 125 having high efficacy. Accordingly, based on such a design requirement 115, the ranking module 230 may rank the LED lighting solutions 125 according to efficacy as determined by the circuit calculation module 225. In some instances, the ranking module 230 may further determine a ranking for the LED lighting solutions 125 accounting for multiple variables simultaneously.

In block 460, the LED design tool application 165 presents LED lighting solutions 125 including various LED array designs 120 accompanied by their respective LED driver solutions. In contrast to the LED lighting solutions 125 presented in block 355 of process 300, the presented LED lighting solutions 125 in block 460 may include multiple different LED array designs 120, not merely LED lighting solutions 125 utilizing a selected LED array design 120. This combined approach has the advantage of presenting the total solution footprint, luminous efficacy and cost for the combined LED/heat sink/driver in one step instead of having to iterate back and forth if several different LEDs or LED array designs 120 are being considered.

For example, an LED lighting solution 125 may be presented including an arrangement of 24 LEDs of a first part number divided into two strings of twelve LEDs, with each string being combined with a first LED driver. In addition, a second LED lighting solution 125 may be presented including an arrangement of 21 LED of a second part number divided into three parallel strings of seven each combined, with each string powered by a second LED driver, and so on. From these listed LED lighting solutions 125, a user may select a LED lighting solution 125 according to the user's design requirements 115. After block 460, the process 400 ends.

FIG. 5 illustrates an exemplary user interface 110-A for the input of design requirements 115 and display of LED array designs 120. The user interface 110-A may include input controls 505 and 510, optimization control 515, a recalculate control 520, a tabular list 525, a graphical display 530, filtering controls 535, and one or more selection controls 530. The user interface 110-A may be generated by a user interface module 205 of an LED design tool application 165, and may allow for a user of a user device 105 to input design requirements 115. The user interface 110-A may further allow for the display and selection of LED array designs 120 determined by the LED design tool application 165 according to the design requirements 115.

The user interface 110-A may provide for the input of one or more design requirements 115 for LED array designs 120 or LED lighting solutions 125. For example, the user interface 110-A may present controls 505 allowing for the input of basic design requirements 115, such as an amount of light output, an ambient temperature, a color, dominant wavelength, or spectrum of light to be produced, minimum and maximum voltage of an available input voltage source, as well as whether the input voltage source is an alternating current or a direct current source. For white LEDs, the design requirements 115 may include a color temperature or color description such as cool white, neutral white or warm white.

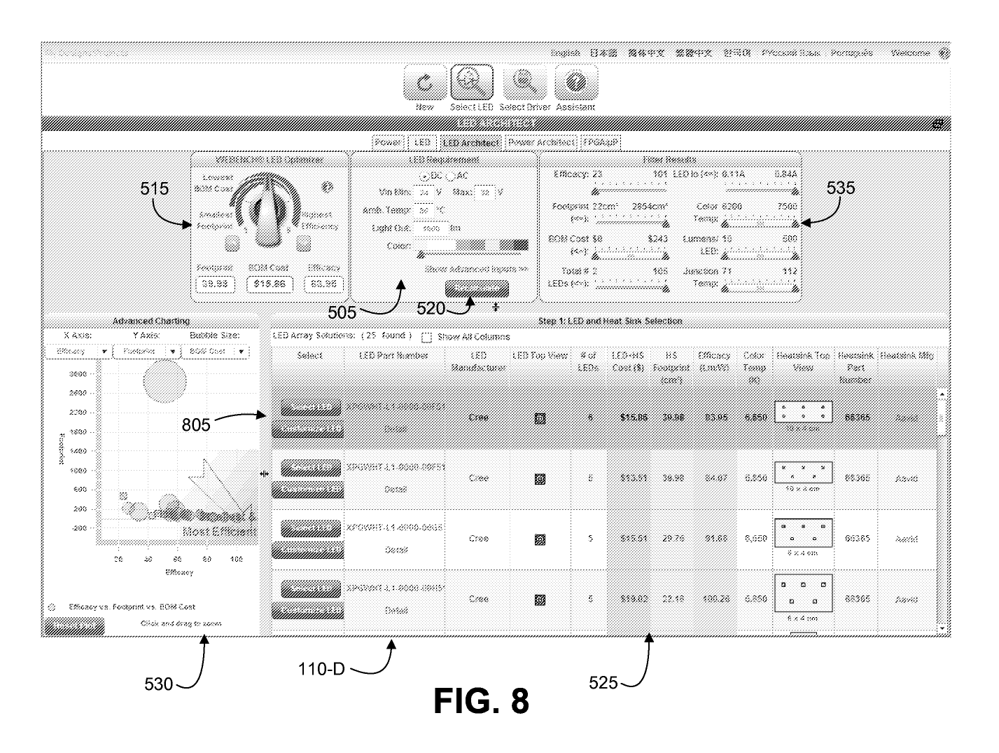

The user interface 110-A may further present controls 510 allowing for the optional input of additional design requirements 115 to be used in the design of LED array designs 120 and LED lighting solutions 125. As some examples, the user interface 110-A may provide for the input of additional design requirements 115 such as a maximum output voltage for the LED driver designs, a maximum number of parallel LED strings allowed on one LED driver; maximum X, Y, and Z dimensions of any required heat sink; a specific LED manufacturer; a maximum junction temperature limit to improve LED system reliability and life; and a preferred parts distributor. Optional input controls 510 may be hidden by a user, such as illustrated in the user interface 110-D of FIG. 8.

Continuing with respect to FIG. 5, the user interface 110-A may further provide for the input of system level goals such as small footprint, low cost, or high efficiency/efficacy. For example, the user interface 110-A may utilize the requirements module 210 to further present an optimization control 515 to a user device 105, such as in the form of a knob, and may receive input from the user from the control 515. The control may allow the user to select a tradeoff indicating a preference for at least one key parameter over a preference for at least one other key parameter. For example, the control may allow the user to prefer designs with small footprint over designs with high efficacy. Based on the input from the optimization control 515, the requirements module 210 may be configured to cause the LED design tool application 165 to calculate LED array designs 120, LED drivers, and/or LED lighting solutions 125 optimized according to the system level goals indicated by the user.

The user may utilize a recalculate control 520 to indicate to the system that the design requirements 115 are entered and that the LED design tool application 165 should determine the LED array designs 120. Upon selection of the recalculate control 520, the LED design tool application 165 may determine a set of LED array designs 120 according to the design requirements 115.

The user interface 110-A further illustrates an exemplary set of generated LED array designs 120. Specifically, LED array designs 120 are included in a tabular list 525 and a graphical display 530 of the LED array designs 120. The tabular list 525 may be created by a tabular display module 235 of the LED design tool application 165, and the graphical display 530 may be created by a graphical display module 240 of the LED design tool application 165.

The LED design tool application 165 may utilize the tabular display module 235 to display the tabular list 525 by way of the user interface module 205, where the tabular list 525 may be configured to display a listing of the determined LED array designs 120. As an example, the tabular display module 235 may present a table in the user interface 110-A including a table of LED array designs 120 with key parameters displayed, with each row in the table indicating a particular LED array designs 120 and associated values and key parameters. Key parameters may include system footprint, system BOM cost, system efficacy, system component count, and system efficiency, among others.

The values in the table may be arranged according to the ranking determined by the ranking module 230. For examples, values in the table may be arranged with the best recommendations at the top of a sortable list. As an example, a design requirement 115 input by way of the optimization control 515 in under interface 110-A may indicate a preference for designs having high efficacy. Accordingly, based on ranking determined by the ranking module 230, the LED lighting solutions 125 may be displayed in order according to efficacy or they may be displayed in order according to a combination of parameters as determined by a weighted scoring algorithm with more weight being given to lighting solutions with high efficacy.

The LED design tool application 165 may utilize the graphical display module 240 to display a graphical display 530 by way of the user interface module 205. Thus, details of the LED array designs 120 may also be displayed graphically in the graphical display 530. For example, in the graphical display 530 the X-axis may represent system efficacy, and the Y-axis may represent system footprint. The circle size in the graphical display 530 may indicate system BOM cost, where a larger circle represents a larger cost, and a smaller circle represents a smaller cost. The axes and the circles may be reconfigured to display different key parameters as well. For example, any of the X-axis, the Y-axis, and the circle size may be reconfigured to represent any of total efficacy, power dissipation, total footprint, total bill of materials cost, total component count, among other key parameters.

The user interface 110-A may allow for the filtering of the set of LED array designs 120 illustrated in the tabular list 525 and graphical display 530 by way of filtering controls 535. The filtering may be performed by a filtering module 535 of the LED design tool application 165, and may allow for filtering of the LED array designs 120 by the user device 105 according to various parameters. Filtering parameters may include a minimum and/or a maximum of one or more of efficacy, footprint, BOM cost, BOM count, LED current, LED color temperature, LED lumens, and LED junction temperature. Because the filtering is performed based on the determined set of LED array designs 120 that form the universe of possible solutions, filtering of the LED array designs 120 may be performed by the user device 105 without requiring any additional database access or interaction with the data store 140 or application server 160.

In some examples, the user interface 110-A may allow for the selection of one of the LED array designs 120, such as by way of one or more selection controls 530. Further details of a selected LED array design 120, such as required LED drivers, may be illustrated based on the selection.

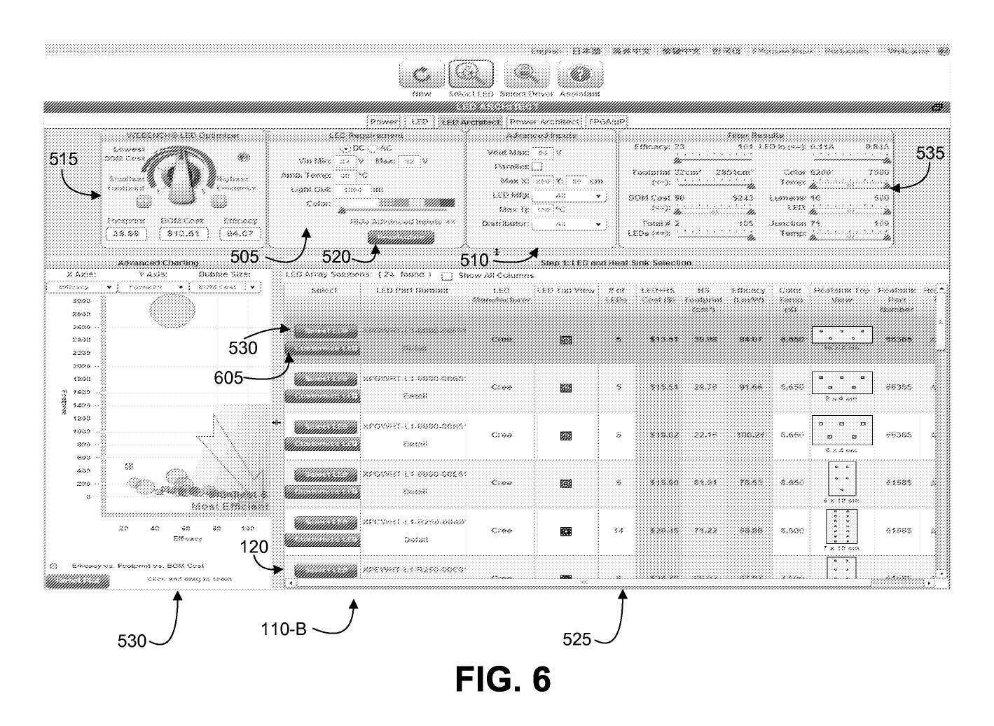

FIG. 6 illustrates an alternate exemplary user interface 110-B for the input of design requirements 115 and the display of LED array designs 120, while allowing for customization of the LED array designs 120. As with user interface 110-A, the user interface 110-B may include input controls 505 and 510, optimization control 515, a recalculate control 520, a tabular list 525, a graphical display 530, filtering controls 535, and one or more selection controls 530. Also as with the user interface 110-A, the user interface 110-B may be generated by a user interface module 205 of an LED design tool application 165, may allow for a user of a user device 105 to input design requirements 115, and may display and allow a user to select LED array designs 120 determined by the LED design tool application 165 according to the design requirements 115.

Moreover, the user interface 110-B may further include a customize LED control 605 configured to allow for customization of the determined LED array designs 120. Thus, in addition to providing for the input of one or more design requirements 115 for LED array designs 120 or LED lighting solutions 125, the user interface 110-B may further provide for the customization of the displayed LED array designs 120 or LED lighting solutions 125. Upon selection of a customize LED control 605 associated with a respective LED array design 120 or LED lighting solution 125, a user interface 110 may be displayed allowing the user to customize various aspects of the associated LED array designs 120 or LED lighting solutions 125.

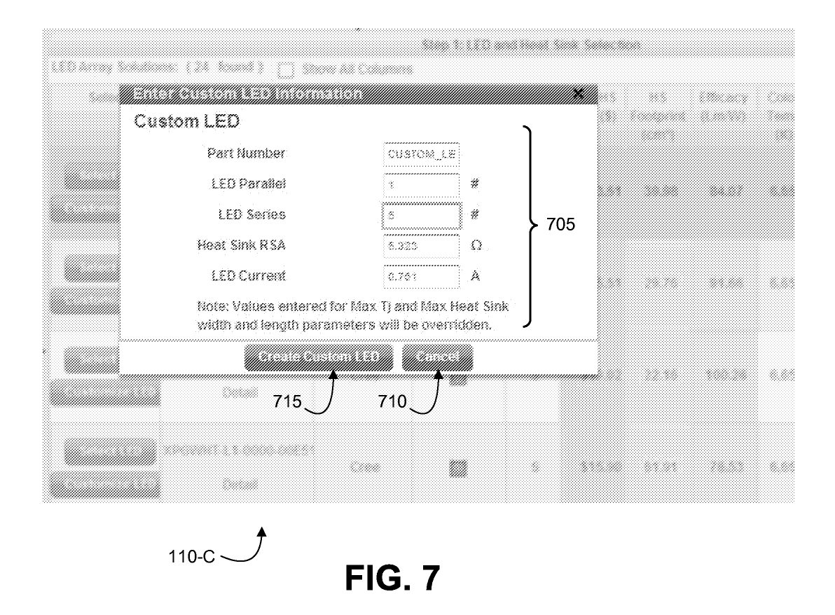

FIG. 7 illustrates an exemplary user interface 110-C for receiving LED array design 120 customizations. For example, the user interface 110-C may be displayed in response to selection of one of the customize LED controls 605 in the user interface 110-B.

The user interface 110-C may include one or more customization controls 705 to allow for the customization of various aspects of the selected LED array design 120. As some examples of aspects that may be customized, the customization controls 705 may allow for adjustment of the part number of the LED used in the LED array design 120, the number of LEDs used in parallel in the LED array design 120, the number of LEDs used in series in the LED array design 120, the heat sink thermal resistance for the associated heat sink for the LED array design 120, and/or the maximum current to be provided to the LED array design 120.

The user interface 110-C may include a cancel control 710 configured to discard any changes made to the LED array design 120. When the cancel control 710 is selected, the user interface 110-C may be hidden and the user interface 110-B may again be displayed, without the application of any customizations to an LED array design 120 or LED lighting solution 125.

The user interface 110-C may further include a create control 715 configured to apply the changes made by way of the customization controls 705 to the LED array design 120 or LED lighting solution 125 being customized. In some instances, the create control 715 may be configured to apply the changes by creating a new customized LED array design 120 or LED lighting solution 125, while in other instances the create control 715 may be configured to overwrite the LED array design 120 or LED lighting solution 125 being customized with the customized version.

When one aspect of a LED array design 120 or LED lighting solution 125 is customized, changes may automatically be made to other aspects of the LED array design 120 or LED lighting solution 125. As an example, if the maximum current of an LED array design 120 is modified by using the customization controls 705, then the light output of the LED array design 120 may correspondingly be increased, as well as the heat dissipation of the LED array design 120. As another example, if the number of LEDs in series is increased, a new heat sink may be required to account for the additional LED.

Accordingly, the user interface 110-C allows the user to modify an existing LED array design 120 or LED lighting solution 125, or to create a new LED array design 120 or LED lighting solution 125 as a customized version of an existing LED array design 120 or LED lighting solution 125. When the create control 715 is selected, the new or overwritten LED array design 120 or LED lighting solution 125 may be added to the available list of LED array designs 120 or LED lighting solutions 125.

FIG. 8 illustrates an exemplary user interface 110-D for the input of design requirements 115 and display of LED array designs, including a customized LED array design 805. As shown, a customized LED array design 805 of the first LED array design 105 of user interface 110-A has been inserted into the tabular list 525. As compared to the LED array design 105 of user interface 110-A having five (5) LEDs, the customized LED array design 805 has been customized to include six (6) LEDs. Additional aspects of the customized LED array design 805 are also updated in accordance with the change. For example, the heat sink has been updated to a heat sink that can accommodate the additional LED. Moreover, the cost, efficacy, footprint and other parameters of the design are updated to account for the changes in components, heat sink, and LEDs.

In the user interface 110-D, the customized LED array design 805 or LED lighting solution 125 is inserted at the top of the tabular list 525. In other examples, the customized LED array design 805 or LED lighting solution 125 may be inserted in other locations, such as at the bottom of the list, or according to any sort criteria already in place for the tabular list 525. Accordingly, the customized LED array design 805 may now be available for selection in the tabular list 525 along with the other LED array designs 120 or LED lighting solution 125.

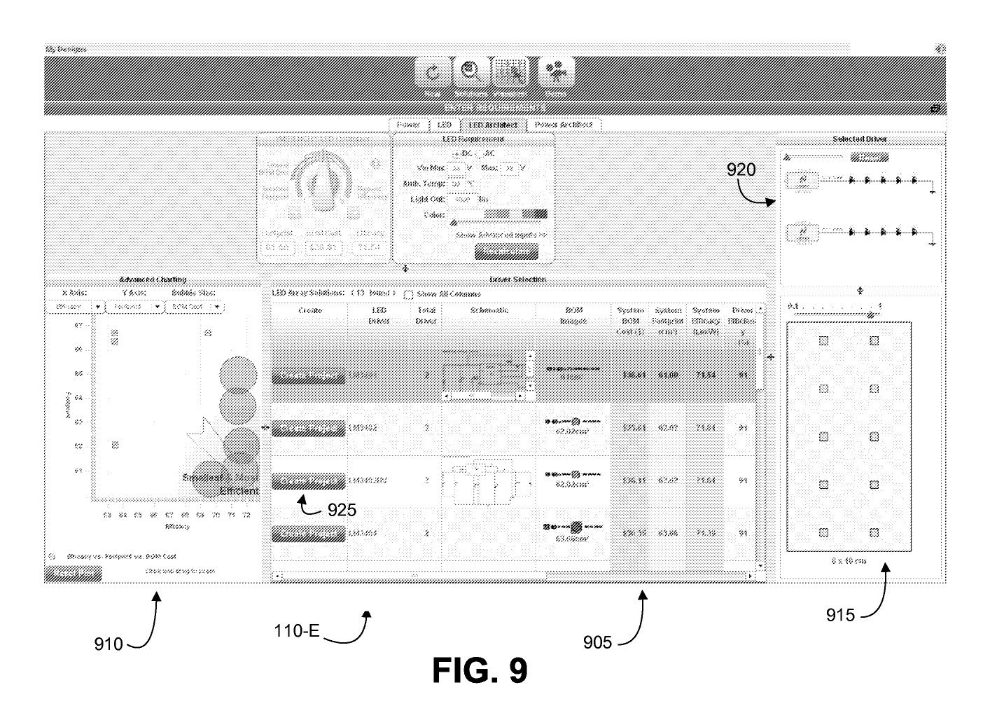

FIG. 9 illustrates an exemplary user interface 110-B for the display of details of a set of LED lighting solutions 125. The user interface 110-B may be generated by a user interface module 205 of an LED design tool application 165, and may include a tabular list 905, a graphical display 910, a heat sink display 915, an LED driver display 920, and a control 925 to allow for the selection of an LED lighting solution 125.

The LED design tool application 165 may use the tabular display module 235 to display the tabular list 905 by way of the user interface module 205. For example, the tabular display module 235 may present in the user interface 110-A a table of LED lighting solutions 125 with key parameters displayed, with each row in the table indicating a particular LED lighting solution 125 and associated values and key parameters. The tabular list 905 may include a listing of LED lighting solutions 125 generated by the LED design tool application 165. The LED lighting solutions 125 may be generated by the LED design tool application 165 based on design requirements 115, such as the design requirements 115 entered into user interface 110-A.

These and other details of the LED lighting solutions 125 may be displayed graphically in the graphical display 910. For example, in the graphical display 910 the X-axis may represent system efficacy, and the Y-axis may represent system footprint. The circle size in the graphical display 910 may indicate system BOM cost, where a larger circle represents a larger cost, and a smaller circle represents a smaller cost. The axis and the circles may be reconfigured to display different key parameters as well. For example, any of the X-axis, the Y-axis, and the circle size may be reconfigured to represent any of total efficacy, power dissipation, total footprint, total bill of materials cost, total component count, among others key parameters.

A user may select from the LED lighting solutions 125 by way of the tabular list 905 and/or the graphical display 910. Based on the selection, the user interface 110-B may display further details of the selected LED lighting solutions 125. For example, the heat sink display 915 may include a graphical depiction of the heat sink and LEDs of a selected LED lighting solution 125. In addition, the LED driver display may include a graphical or schematic depiction of the one or more LED drivers and LEDs included in the selected LED lighting solution 125.

Based on the additional information, the user may determine an LED lighting solution 125 for further consideration or use. For example, the user may select the control 925 to allow for the selection of an LED lighting solution 125. Upon selection of a LED lighting solution 125 by way of the control 925, the LED lighting solution 125 may be input into a design tool for further analysis, such as the WEBENCH Power Designer provided by National Semiconductor.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a database configured to store information including characteristics of a plurality of components; and
a server in communication with the database and configured to:
receive design parameters indicative of characteristics of an LED lighting solution;
determine a plurality of LED lighting array designs, each design including at least one of a parallel and a series arrangement of LEDs and configured to provide an amount of light specified by the design parameters;
for each one of at least a subset of the plurality of LED lighting array designs, determine an LED driver design configured to power the one of the LED lighting array designs; and
generate at least one LED lighting solution, each LED lighting solution including one of the LED lighting array designs combined with one of the LED driver designs configured to power the one of the LED lighting arrays.

2. The system of claim 1, wherein the stored database information includes information on a plurality of types of LEDs that may be usable in the generation of LED array designs, and where the server is further configured to:
utilize the design requirements to retrieve LED information from the database responsive to the design requirements; and
determine a set of types of candidate LEDs based on the retrieved LED information.

3. The system of claim 2, wherein the server is further configured to determine a best LED operating current for one of the set of types of candidate LED, a number of the one type of candidate LED required to generate the desired amount of light, and parameters of a heat sink required to keep a temperature of the one type of candidate LED within a temperature operating limit of the candidate LED.

4. The system of claim 3, wherein the temperature operating limit of the one type of candidate LED is included in the stored database information.

5. The system of claim 3, wherein the temperature operating limit of the one type of candidate LED is defined to achieve a desired LED lifetime.

6. The system of claim 3, wherein the stored database information includes information on a plurality of types of heat sink that may be usable in the generation of LED array designs, and where the server is further configured to:
determine a thermal resistance value between each of at least a subset of the plurality of types of heat sink and air based in part on the design requirements; and
select at least one heat sink from the heat sink information capable of satisfying the determined thermal resistance value and the temperature operating limit of the candidate LED.

7. The system of claim 6, wherein the server is further configured to select the at least one heat sink further based on whether the heat sink is capable of holding a number of LEDs required to generate the desired amount of light.

8. The system of claim 6, wherein the thermal resistance value is determined based on at least a subset of an ambient temperature specified in the design requirements, an LED operating current for the candidate LED, and modeled parameters in the database regarding the plurality of types of heat sink.

9. The system of claim 1, wherein the server is further configured to:
calculate an LED forward voltage and a required output current for one of the LED lighting array designs wired in a series arrangement; and
determine whether any LED drivers can power the series arrangement based on the LED forward voltage and required current.

10. The system of claim 9, wherein LED drivers are determined to be unable to power the series arrangement if at least one of the LED forward voltage is too high and the required output current is too high.

11. The system of claim 1, wherein the server is further configured to:
divide the LED array into a plurality of parallel strings of LEDs; and
determine LED drivers for each of the plurality of parallel strings of LEDs.

12. The system of claim 11, wherein each of the plurality of parallel strings is of equal length.

13. The system of claim 11, wherein the server is further configured to increase the number of LEDs in the LED array design to allow for the division of the LED array into a plurality of parallel strings of equal length.

14. The system of claim 13, wherein increasing the number of LEDs further includes decreasing an amount of output current to be output to the LED array design such that the resultant about of light would remain constant.

15. A method, comprising:
receiving design parameters indicative of characteristics of an LED lighting solution;
retrieving LED information from a database responsive to the design requirements, the database including characteristics of a plurality of LED lighting solution components;
determining a set of types of candidate LED based on the retrieved LED information;
determining, by a processing device, an LED lighting array design configured to provide light responsive to the design parameters, the LED lighting array design including a plurality of LEDs of a first type of the types of candidate LED with at least one of a parallel and a series arrangement of LEDs; and
determining, by the processing device, at least one LED driver design configured to power the LED lighting array design; and
generating at least one LED lighting solution, each LED lighting solution including the LED lighting array design powered by one of at least one LED driver design configured to power the LED lighting array.

16. The method of claim 15, further comprising determining a second LED lighting array design including a plurality of LEDs of a second type of the types of candidate LEDs and configured to provide light responsive to the design parameters.

17. The method of claim 15, further comprising:
determining an LED operating current for the LEDs of the first type;
determining a number of the LEDs of the first type required to generate the desired amount of light; and
determining parameters of a heat sink required to keep a temperature of the LEDs of the first type within a temperature operating limit of the LEDs of the first type.

18. The method of claim 17, further comprising:
determining a thermal resistance value between a heat sink and air for the heat sink based in part on an ambient temperature specified by the design requirements; and
selecting at least one heat sink from the heat sink information from the database capable of satisfying the thermal resistance value for the heat sink.

19. The method of claim 15, further comprising:
calculating an LED forward voltage and a required output current for the LED array wired in a series arrangement; and
determining the at least one LED driver design based on the LED forward voltage and required current of the series arrangement.

20. The method of claim 15, further comprising:
dividing the LED array into a plurality of parallel strings of LEDs; and
determining LED drivers for each of the plurality of parallel strings of LEDs.

21. The method of claim 15, further comprising:
including at least one additional LED to the LED array design to allow for the division of the LED array into a plurality of parallel strings of equal length;
dividing the LED array into a plurality of parallel strings of LEDs in series, each parallel string being of equal length;
determining at least one of the at least one LED driver design as being configured to power the plurality of parallel strings.

22. The method of claim 15, further comprising:
receiving a customization of at least one aspect of an LED array design and an LED lighting solution; and
updating the at least one of an LED driver and the LED lighting solution based on the at least one aspect.

23. A computer-readable medium tangibly embodying computer-executable instructions configured to cause a computing device to:
receive design requirements indicative of characteristics of an LED lighting solution;
retrieve LED information from a database responsive to the design requirements, the database including characteristics of a plurality of LED lighting solution components;
determine a set of types of candidate LEDs based on the retrieved LED information;
determine a thermal resistance value between a heat sink and air for a heat sink based in part on the design requirements;
select at least one heat sink capable of satisfying the determined thermal resistance value from heat sink information stored in the database;
determine a plurality of LED lighting array designs, each LED lighting array design including one of the at least one heat sinks and a plurality of LEDs of one of the types of candidate LED, the plurality of LEDs including at least one of a parallel and a series arrangement of LEDs, each LED lighting array design being configured to provide light responsive to the design parameters;
determine at least one LED driver design configured to power at least a subset of the LED lighting array designs; and
generate at least one LED lighting solution, each LED lighting solution including one of the plurality of LED lighting array designs powered by one of at least one LED driver designs.

24. The computer-readable medium of claim 23, further comprising instructions configured to cause the computing device to:
generate a requirements web site configured to receive the design requirements; and
send the requirements web site to a user device.

25. The computer-readable medium of claim 23, further comprising instructions configured to cause the computing device to:
generate a results web site configured to cause a user device to display the generated at least one LED lighting solution in accordance with the plurality of design requirements; and
send the results web site to the user device.
